(19) United States
(12) Patent Application Publication
(10) Pub. No.: US 2007/0127144 A1
(43) Pub. Date: Jun. 7, 2007

(54) Optical film and frame with high resistance to thermal distortion

(75) Inventor: Zhanjun Gao, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/294,939

(22) Filed: Dec. 6, 2005

(51) Int. Cl. G02B 7/02

(52) U.S. Cl. 359/820

(57) ABSTRACT

This invention relates to an optical film/frame combination wherein the optical film comprises a viewing portion and wherein either the film or the frame comprises a compression reducing mechanism for allowing the film to expand within the frame without distortion of the viewing portion of the film.

### FIELD OF THE INVENTION

The present invention relates to an optical film and frame, and more particularly to a compression mechanism which eliminates buckling of the optical film when the film is heated.

### BACKGROUND

Multilayer and microstructured polymeric optical films are widely used for various purposes, including as mirrors, polarizers and light redirection films. These films often have extremely good optical properties, while being lightweight and resistant to breakage. Thus, the films are well suited for use as reflectors and polarizers in compact electronic displays, including as liquid crystal displays (LCDs), OLEDs, placed in mobile telephones, personal data assistants, and portable computers.

Reflector, diffuser, and light redirection films are found in the backlights of transmissive LCD's. Such a backlight is illustrated in FIG. 1 which illustrates a sectional view of the back light module 100. The back light module 100 comprises a light guiding plate 11, a reflective plate 12, a lamp 13, an optical film assembly 14 consisting of a plurality of thin films and an aluminum back cover 15. The light guiding plate 11 is an injection molded or extruded acrylic sheet with circular, hexagonal or square diffusion dots 16 for scattering light formed by screen printing or direct injection on the bottom surface thereof. The reflective plate 12 is disposed beneath the light guiding plate 11 and reflects the light transmitted through the bottom surface of the light guiding plate 11 so as to return the light to the light guiding plate 11 to increase utilization of light. The lamp 13 is disposed at the side of the light guiding plate 11 and is generally composed of a cold cathode fluorescent lamp (CCFL) that sends light into the light guiding plate 11 in a manner of end illuminating. The optical film 14 is placed on the top surface of the light guiding plate 11 with the composition and function thereof described hereafter. The aluminum back cover 15 is mounted at the bottom and the side of the back light module 100 for supporting and protecting the back light module 100 and the elements therein.

Referring to FIG. 2, which is a schematic sectional diagram of the optical film 14 of the back light module 100, the optical film assembly 14 comprises a plurality of thin films and is placed on the top surface of the light guiding plate 11. The thin films include a lower diffusion sheet 141, a prism sheet 142, and a reflective polarizing film 143. The composition of the thin film assembly in FIG. 2 is merely one example of the optical film assembly 14.

The means to position and constrain an optical film in the display module are critical to the robust and environmentally stable performance of the LCD. A positioning means may help to fix the optical film on the top surface of the light guiding plate so to avoid film displacement resulting from transportation or assembly, and to reduce the adjusting time of the optical film during the back light module assembly. Furthermore, when the back light module is tested for reliability, such as falling or vibration, etc., the optical film is liable to displace if the fixing effect of the positioning means is not adequate. This may produce poor quality in appearances of pictures such as dark lines or bright lines. On the other hand, a fully constrained optical film will be prevented from free expansion when the temperature of the display module rises, resulting in buckling of the optical film.

One existing technique to prevent the optical film from thermal buckling is to leave a small gap between the film and the frame to allow the optical film to expand. But the gap cannot be too big or the film will move around in the frame. Therefore, this technique does not work for film with a high coefficient of thermal expansion, or for large size displays. Furthermore, a larger gap between the film and the frame will also increase light leakage around the film edges.

U.S. Pat. No. 6,160,663 describes an assembly comprising a film bounded by a frame, the film having a first thermal expansion coefficient along a first direction parallel to the film and a second thermal expansion coefficient along a second direction parallel to the film, wherein thermal expansion of the film compared to that of the frame is greater along the first direction than along the second direction, and wherein the film has a shape at an ambient reference temperature different from that of the frame, the shape of the film being selected to reduce clearance while allowing sufficient room between the film and the frame for thermal expansion in the first direction for temperatures up to a predetermined elevated reference temperature. One of the limitations of this method is that it does not deal with films that develop out of plane bending (warping) during free expansion.

U.S. Pat. No. 6,673,425 describes multilayer optical bodies that contain an optical film joined to one or more dimensionally stable layers. The dimensionally stable layers support the optical film such that the composite multilayer optical body resists warping after exposure to temperature fluctuations, while maintaining the light weight, durability, and flexibility of the optical film. U.S. Pat. No. 6,673,425 is also directed to methods of making optical bodies and to displays (such as LCDs) containing the optical bodies.

There is still a need to develop effective ways to constrain one or more optical films in a display apparatus without thermal buckling or free movement of the one or more films.

### SUMMARY OF THE INVENTION

This invention addresses the thermal buckling problem by introducing an optical film/frame combination wherein the optical film comprises a viewing portion and wherein either the film or the frame, or both, comprises a compression reducing mechanism for allowing the film to expand within the frame without distortion of the viewing portion of the film. In one embodiment the optical film comprises the compression reducing mechanism, with said compression reducing mechanism being a compression reducing portion of the film. In another embodiment the frame comprises the compression reducing mechanism.

This invention eliminates or reduces the thermal buckling of an optical film that results from the heating of the optical film during use in a display apparatus. The compression reducing mechanism reduces the deformation or buckling of the viewing portion of the film. This invention further provides a means for preventing the optical film from moving around too freely in the optical frame. This invention is particularly useful for optical film/frame combination wherein the optical film has a diagonal of 9 to 70 inches, and more preferably of 19 to 55 inches.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a cross sectional view of a conventional back light module;

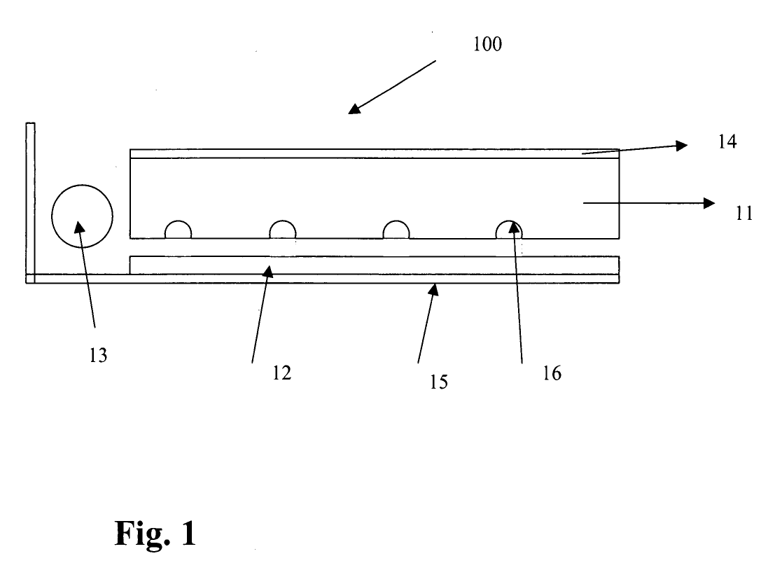

FIG. 2 is a schematic cross sectional diagram of a conventional optical film utilized in a back light module,

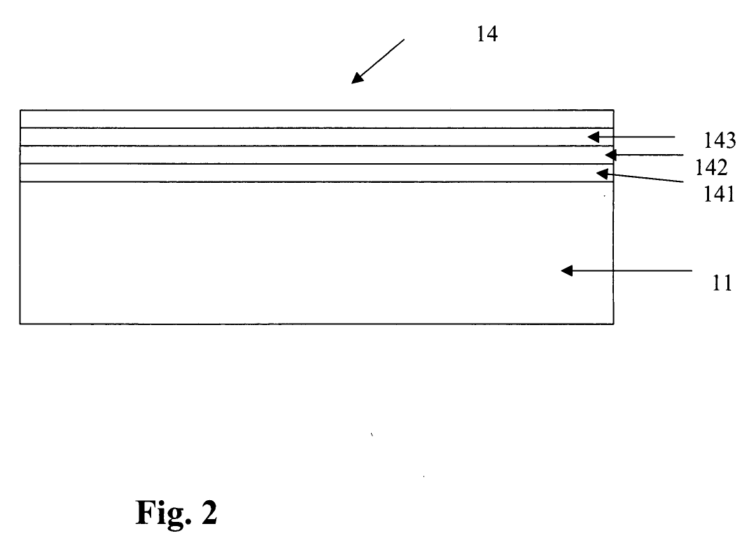

FIG. 3 is a side view of one embodiment of an optical film with a buckling section;

FIG. 4 is a side view of an optical film with a buckling section in a optical frame;

FIG. 5 is a side view of an optical film in a buckled state in a optical frame;

FIG. 6 depicts top and side views of an optical film in an optical frame;

FIG. 7 is a side view of another embodiment of an optical film with a buckling section;

FIG. 8 is a side view of another embodiment of an optical film with a buckling section in a optical frame;

FIG. 9 is a schematic of a stamp press/embossing apparatus;

FIG. 10 depicts one embodiment of an optical frame comprising a compression reducing mechanism in the form of a spring;

FIG. 11 depicts one embodiment of an optical frame comprising a compression reducing mechanism in the form of tabs;

FIG. 12 is a thermal distortion profile for a conventional optical film;

FIG. 13 is a thermal distortion profile for one embodiment of the invention wherein the thermal distortion is confined to the buckling section of the film;

FIG. 14 is a thermal distortion profile for one embodiment of the invention wherein the optical film remains essentially flat.

### DETAILED DESCRIPTION OF THE INVENTION

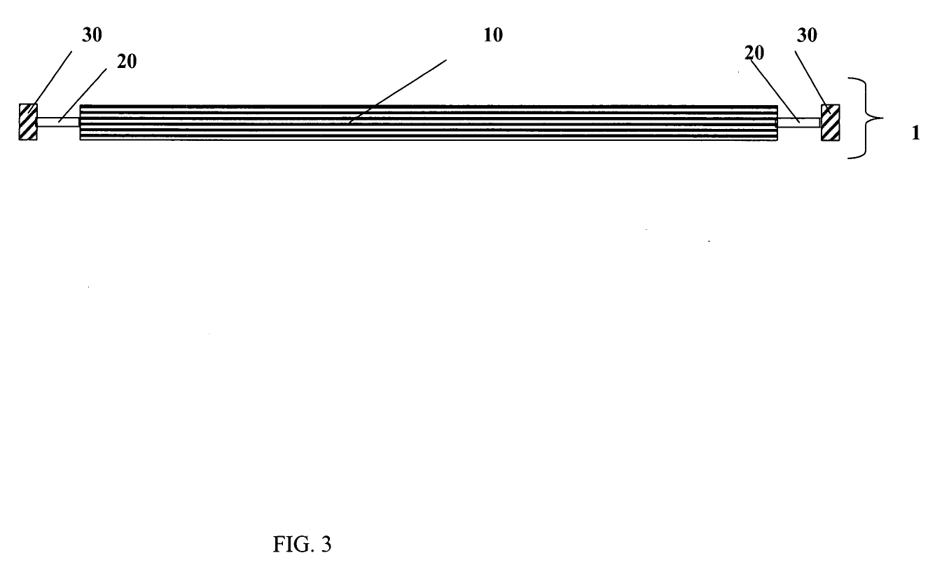

As stated above, the present invention provides an optical body that resists thermal buckling. One preferred embodiment of this invention addresses the thermal distortion problem by introducing a compression reducing portion (also called the buckling section) on at least one edge of the optical film within the optical frame. More preferably the compression reducing portion of the film is on at least one edge of the optical film. Referring to FIG. 3, which is a cross-sectional view of one embodiment of the optical film in this invention, the optical film 1 contains three sections, main section (viewing portion) 10, buckling section (compression reducing portion) 20, and end section 30. The main section 10 is the viewing portion of the film. The buckling section 20 is a small portion of the film normally under the optical frame that has a lower resistance to thermal driven buckling in comparison with to the main section 10. The buckling resistance is proportional to the cubic of the thickness of the optical film and its Young's modulus.

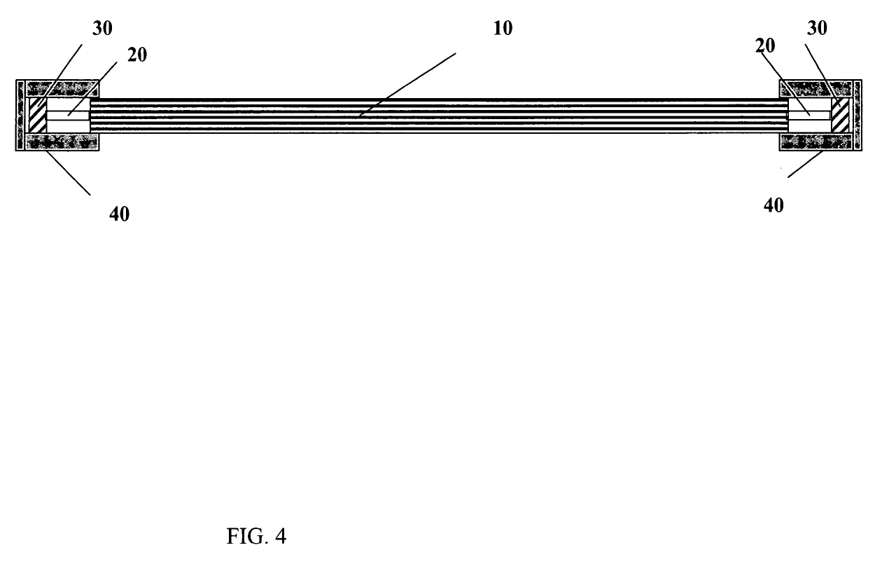

The main section 10 and the buckling portion 20 may be comprised of the same or different materials. One way to achieve the lower buckling resistance is to make section 20 thinner than section 10 such as shown in FIG. 4. Another way is to use a material with lower Young's modulus for section 20. In one embodiment the buckling section 20 has a Young's modulus that is at least 20% lower than that of the main section of the optical film. In another embodiment the optical film comprises the compression reducing portion on at least one edge of the film and the bending stiffness of the compression reducing portion 20 of the film is 80% or less of the bending stiffness of the optical film in the viewing portion 10.

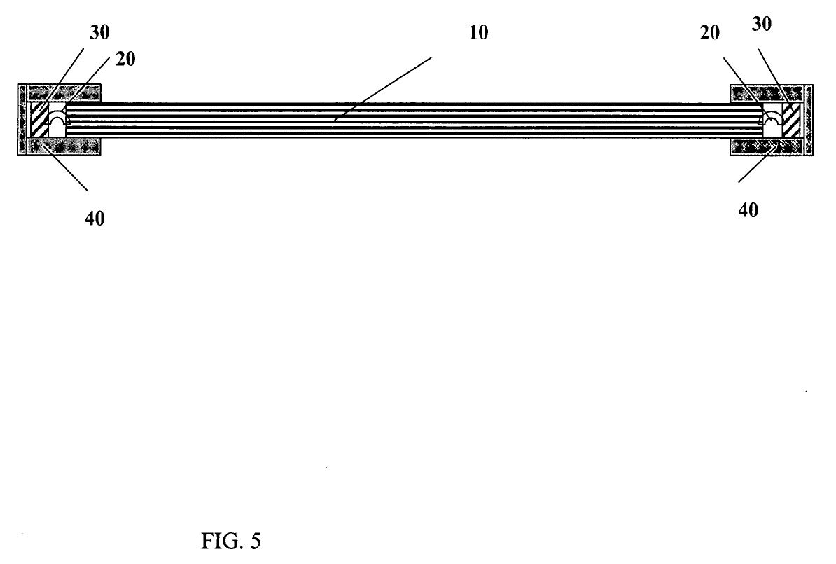

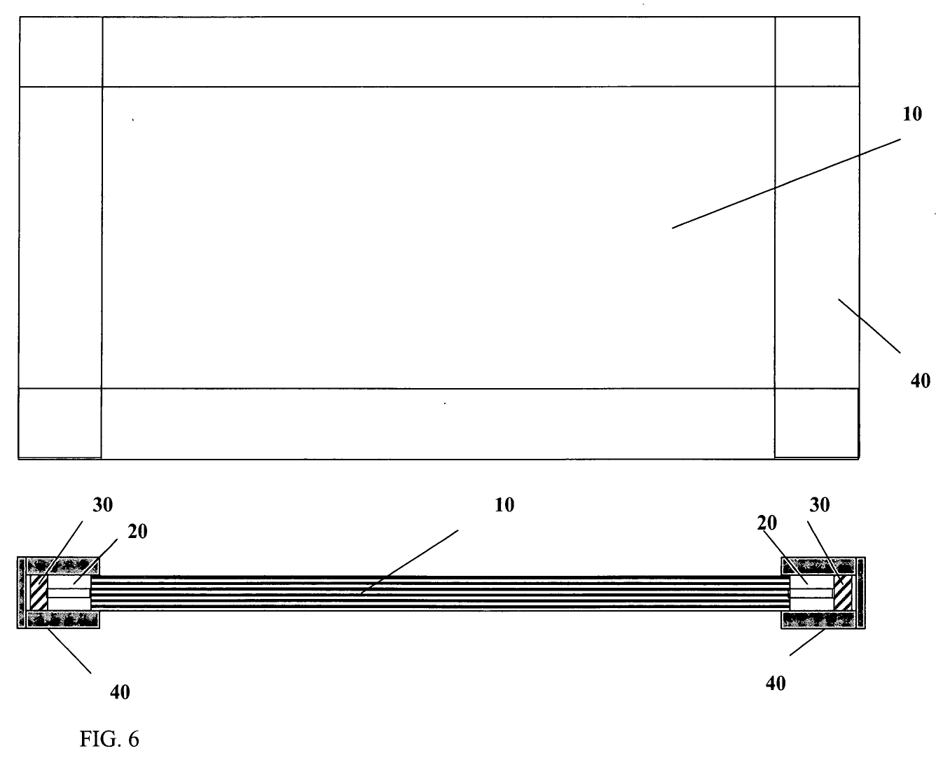

Section 30 is the end section of the optical film. Section 30 may have the same properties as section 10. Section 30 may be eliminated so that section 20 extends to the end of the optical film. FIG. 4 shows a side view of the optical film with a buckling section 20 in an optical frame 40. FIG. 5 shows the optical film under thermal expansion. The buckling of the buckling section 20 accommodates the expansion of the main section 10 of the optical film so that buckling will not occur in the main section 10. This eliminates the distortion of the optical film in main section 10, which is the viewing portion of the display. FIG. 6 shows both front and side views of the optical film in an optical frame. The buckling section 20 may exist in one, two, three or four edges of the optical film.

The mechanics under which the buckling section 20 works can be explained using the theory of thin plate buckling under in-plane compressive loading as outlined below. The compressive loading in this case is generated by thermal expansion of the optical film with its edge constrained. The ability of the plate to resist buckling out of plane is represented by the flexural rigidity of the plate, D, defined as

$$D = \frac{{Eh}^{3}}{12 ( 1 - {v}^{2} )} \qquad ( 1 )$$

where E and v are the Young's modulus and Poisson's ratio of the plate, respectively, h is its thickness. If the plate made of optical film has more than one section, the section with the lower flexural rigidity will buckle first. It is clear from Eqn. (1) that one way to create the buckling section with lower flexural rigidity is to make the buckling section thinner such as the embodiment shown in FIG. 4. Another way is to use a material with a lower Young's modulus such as discussed above.

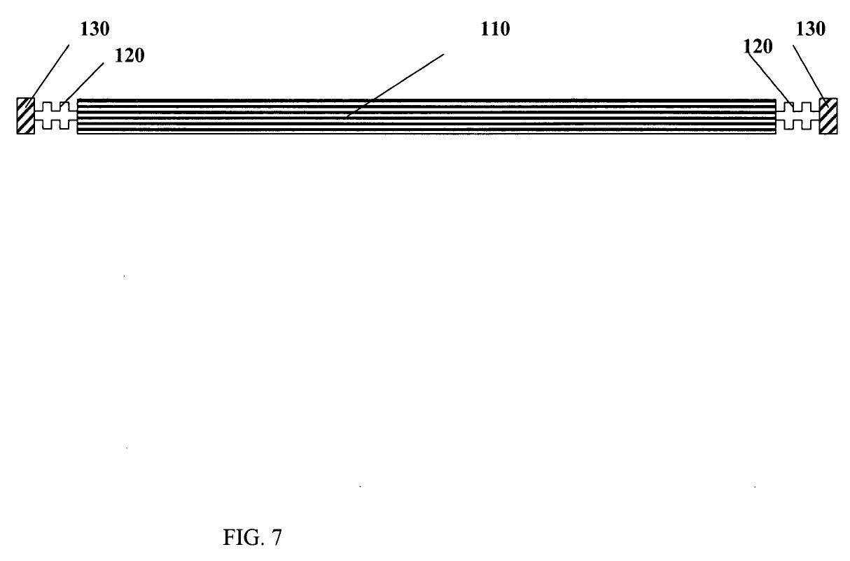

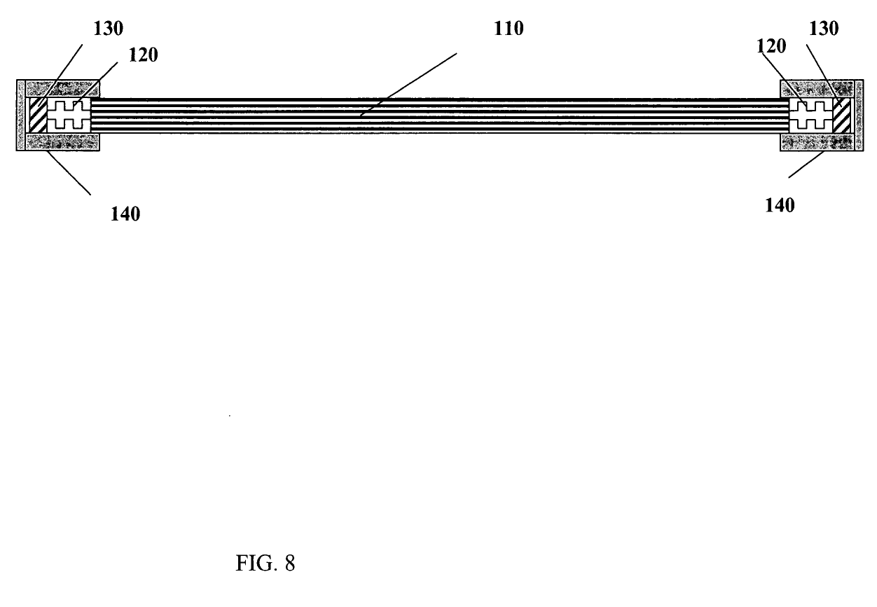

The buckling section may be grooved such as buckling section 120 in FIG. 7. The buckling section 120 has waviness or grooves such that it has lower buckling resistance in comparison to the main section 110. Again, the buckling section 120 may exist in only one, two, or three edges or all four edges of the optical film. The buckling section may also be discontinuous, by this it is meant that the buckling section or compression reducing portion of the film may contain features such as, pores, holes, slits, slots, wedges or other types of cut-out portions or their combinations. These features may be arranged in a periodic or non-periodic fashion, and may not necessarily cover all areas of the buckling section. FIG. 8 shows the grooved film in an optical frame.

The preferred thickness of the optical film is from 10 μm to 1000 μm. Some particularly suitable materials are polycarbonate, amorphous polyethylene terephthalate (PET), polyethylene naphthalate (PEN) or polyethersulfone (PES). This invention is particularly useful with optical films consisting of materials with a coefficient of thermal expansion higher than 10 ppm/C.

In another embodiment of the invention the buckling section and the main section may be comprised of different materials. In this case the buckling section is preferably comprised of a material having a Young's modulus of at least 20% less than the material of the main section (viewing portion). For example, the main section may comprise PEN and the buckling section may comprise PET. When different materials are used the buckling section may incorporate the above described features of being thinner, being discontinuous etc. but if the appropriate materials are chosen this preferably will not be necessary.

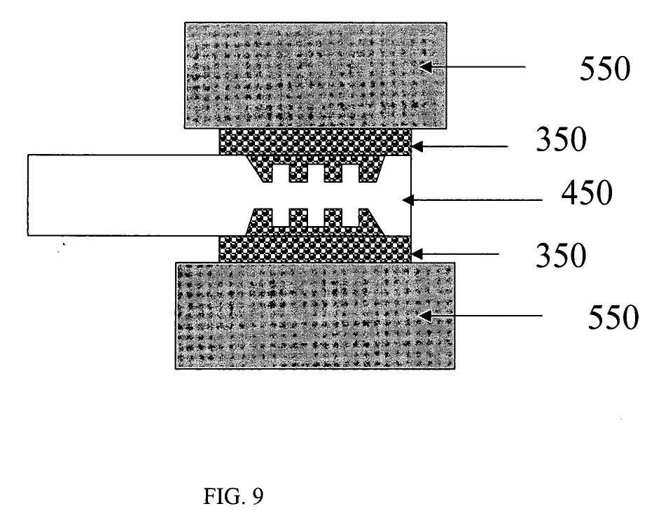

There are many ways that can be utilized to manufacture the optical film with the buckling section that has a lower resistance to buckling. One way is to use the hot stamping/embossing process as shown in FIG. 9. The apparatus contains hot plates 550 and stamps 350. Hot stamping on a smooth surface is carried out by pressing the optical film 450 via the stamps 350 to form a desired pattern. The embossing process is applied to only the edge areas of the display.

By utilizing various stamps 350, one can generate the buckling section with various features such as pores, hole, slits, slots or other types of cut-out portions or their combinations. For example, it is easy to create small holes, evenly or non-evenly distributed along one direction of the buckling section. It is also possible to have grooves along the other direction of the buckling section. These holes and grooves can be arranged in various patterns along the two main direction of the optical frame (and buckling section). Of course the key is to reduce the buckling resistance of the buckling section. This can be achieved by other structures or their combination mentioned above. The compression reducing portion of the film created this way often has a two dimensional distribution of features such as holes, grooves, slits, as well three dimensional distribution of features such as the depth of the grooves.

Various techniques can be utilized to manufacture the optical film wherein the viewing portion and the compression reducing portion of the film are comprised of different materials. One of such techniques is extrusion. Extruding a coating of polymer or blends of polymers onto a substrate, such as paper or aluminum foil, to form an extrusion coated substrate, is well known in the art, see, for example, U.S. Pat. No. 4,152,387. Extruding multiple layers of polymers including polyolefins as well as other materials in a process known as co-extrusion is also well known. Various polyethylenes and blends of polyethylenes have been used widely as extrusion coating compositions. Such materials have also been used in coextrusion processes as the layer adjacent to the substrate so as to adhere the coating to the substrate. In order to manufacture the optical film wherein the viewing portion and the compression reducing portion of the film are comprised of different materials, one needs to use separate extrusion dies that introduce different polymers to the viewing portion and the compression reducing portion of the film. In the direction of the film transverse to the web moving direction during manufacturing, the compression reducing portion of the optical film can be laminated with the viewing portion of the film to join them together. This requires a small area of overlapping the compression reducing portion and viewing portion of the film during the lamination process.

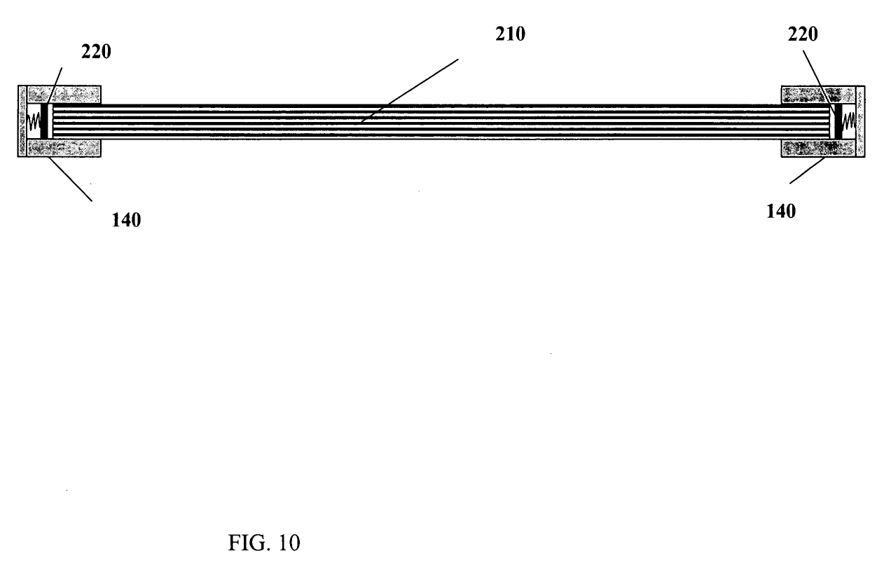

Another preferred embodiment is to introduce a compression reducing mechanism to the optical frame (also called optical frame) to eliminate buckling of the optical film. In one embodiment such as shown in FIG. 10 the compression reducing mechanism is a spring located between the optical frame 140 and the optical film 210. In the preferred embodiment shown in FIG. 10, the thermal buckling problem is addressed by introducing an end plate with a spring 220. The spring is attached to the frame at one end, and to the end plate in the other end. The end plate is allowed to move within the plane of the film to accommodate the expansion and contraction of the optical film. In such a way, the buckling and distortion due to thermal expansion will not occur. The film will not move around freely in the frame at the ambient condition when the display is on powered on.

In another embodiment the compression reducing mechanism is a bending element located along at least one edge of the optical frame between the frame and the optical film, wherein said bending element deflects to provide resistance to the optical film. Preferably the bending element is made of thermoplastic with a Young's modulus higher than 1 GPa. The compression reducing mechanism may also be a compression element located at one or more edges of the optical frame, wherein said compression element deforms to provide the resistance to the optical film. For example, the compression element is made of a rubbery material.

Elastomers and rubber materials are characterized by their high degree of flexibility and elasticity. They are based on a variety of chemical systems. Examples include acrylics and polyacrylates; butyl, polybutene and polyisobutylene polymers; ethylene copolymers; fluropolymers such as polytetrafluorethylene (PTFE); silicone, polyurethane, and polyether block amide (PEBA); styrene butadiene rubber (SBR); and vinyl and polyvinyl chloride (PVC). Polyurethane or polystyrene is particularly suitable.

Important specifications for elastomers and rubber materials include mechanical, thermal, electrical, optical, processing, and physical properties. For the use of elastomers and rubber materials in this invention, the Young's modulus is an important characteristic. A suitable elastomer/rubber for the present invention has a Young's modulus in the range from 1 MPa to 100 MPa.

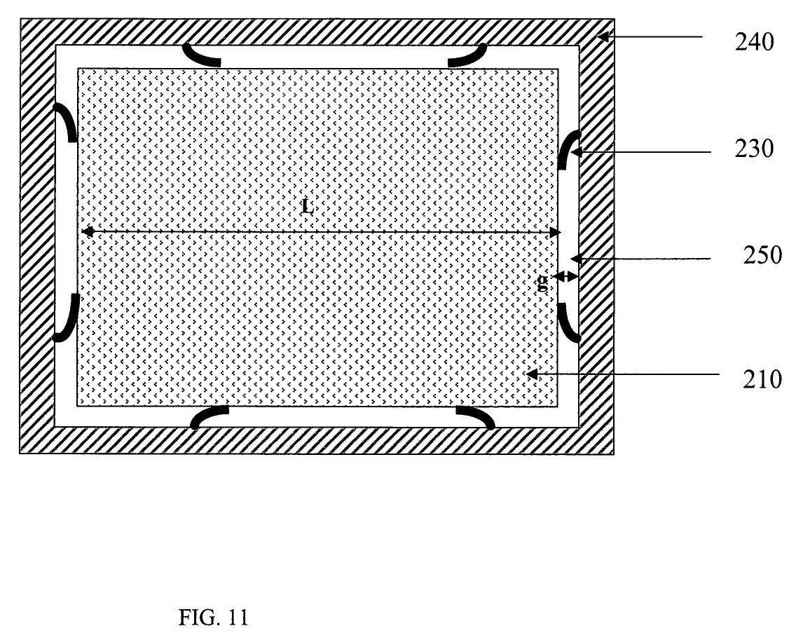

There are various simple ways to incorporate compression reducing mechanism into the frame without using separate mechanical parts. For example, when the compression reducing mechanism is a bending element it can be made as small tabs 230 shown in FIG. 11. These tabs 230 are generally in a gap 250 between the film 210 and the frame 240 and will bend toward the frame 240 when the film expands. These tabs are part of the frame and can be manufactured together with the frame using injection molding. The added cost is minimal. The material and dimensions of the tabs 230 can be chosen in such a way that no failure occur when the tabs are pushed fully against the frame. Of course, the number, configuration, and shape of the tabs are not limited by FIG. 11. Furthermore, the tabs 230 may exist in only one, two, or three edges or all four edges of the optical frame.

There are several design considerations for the compression reducing mechanism, such as the spring or tabs in the embodiments in FIGS. 10 and 11. First the spring constant, defined as the ratio of the force on the compression reducing mechanism to its deflection, needs to be appropriate to provide the right level of the resistance to the film expansion while allow the film to deflect the compression reducing mechanism to accommodate the film's expansion. If the value of the spring constant is too low, the compression reducing mechanism will be pushed against the frame when the optical film expands, rendering the compression reducing mechanism useless. On the other hands, if the value of the spring constant is too high, the compression reducing mechanism will not deflect enough to accommodate the film expansion, which may still lead to buckling of the optical film. Based on these two considerations, the conditions for appropriate spring constant are

$$\begin{matrix}k \geq \frac{αΔ TEh}{g} \\ and & ( 2 a ) \\ k \leq \frac{{N}_{cr} Eh}{( αΔ TEh - {N}_{cr} ) L} & ( 2 b )\end{matrix}$$

where N_{cr} is the critical force for the film to buckle, L is the length of the film, g is the gap between the film and the frame, k is the spring constant, α is the coefficient of thermal expansion of the film, h is the thickness of the film, and E is the Young's modulus of the film. ΔT is the expected temperature change. Apparently, it is required that αΔTEh be larger than N_{cr}. Otherwise, the film will not buckle even when it is fully constrained from expansion. Equation (2a) represents the fact that the compression reducing mechanism is stiff enough to prevent the film to expand to the frame. Equation (2b) implies that the compression reducing mechanism is soft enough such that the compression force in the optical film is less than the critical value to cause buckling. In one embodiment of the invention, the film may comprise a compression reducing portion and the frame may also comprise a compression reducing mechanism such as tabs or springs.

Polymers used for the tabs should have sufficient elongation to break so that when the tabs deform, they will not break. Some of the useful thermoplastic materials for the tabs are listed below.

| | |
|---|---|
| ACI Plastics | ABS, Nylon 6, Nylon 6/6, Polycarbonate, PC/ |
| USA | Acrylic Alloy, PC/PBT Alloy, PPO-PA Alloy, TPO. |
| Advanced | Santoprene ™ thermoplastic rubber |
| Elastomer | Santoprene ™ 8000 thermoplastic rubber |
| Systems | Vyram ™ thermoplastic rubber |
| USA | Geolast ™ thermoplastic rubber |
| | Trefsin ™ thermoplastic rubber |
| | Vistaflex ™ thermoplastic elastomer |
| | Dytron ™ XL thermoplastic rubber |
| Alpha Gary | Consumer Performance TPE's. Evoprene, Evoprene |
| USA | G, Evoprene Super G, Evoprene and Evoprene GC. |
| Aquafil | Vast range of compounds of PA 6 and PA 66 for |
| Technopolymers | moulding and extrusion, marketed with the |
| Italy | trademark Aquamid and Econyl. |
| Asahi Kasei | Synthetic rubber and resins. |
| Asia | Leona ® polyamide 66 |
| | Tenac ® polyacetal homopolymer |
| | Tenac-C ® polyacetal copolymer |
| | Xyron ® modified polyphenylene ether |
| Atoglas | Acrylic molding and extrusion resins and |
| USA, Mexico, | acrylic sheet sold under the trade names Plexi- |
| Korea | glas ® in North and Latin America, and Altu- |
| | glas ® in Asia/Pacific, Europe, Africa and |
| | the Middle East. Atoglas also markets the |
| | Tuffak ® polycarbonate |
| Bada Plast | Polyamid-masses based on PA6, PA66 and |
| Germany, | different Copolyamides like PA 6/66 and |
| England | PA 66/6. |
| Basell | World's largest producer of polypropylene and |
| The | advanced polyolefins products, a leading |
| Netherlands | supplier of polyethylene and catalysts, and a |
| | global leader in the development and licensing |
| | of polypropylene and polyethylene processes. |
| BASF | BASF is one of the leading global producers |
| Germany, USA | of styrenics, engineering plastics and poly- |
| | urethanes. |
| Bayer USA | Thermoplastic engineering resins, polyurethane |
| | raw materials and systems, technologies and |
| | processing equipment for a wide range of |
| | polymer applications. |
| Belpak | PET and blow molding resins. |
| Russia | |
| Berga | PVC granulates and dryblends in individual |
| Germany | colours and qualities. |
| Borealis | polyethylene (PE) and polypropylene (PP). |
| France | |
| Borouge | low-density (LLD), medium-density (MD) and |
| Middle East | high-density (HD) polyethylene for use in the |
| and Asia | flexible and rigid packaging as well as pipe |
| Pacific | industries. |
| BP Chemicals | Core products include olefins, polypropylene, |
| United Kingdom | HDPE (high density polyethylene), acrylonitrile, |
| | paraxylene (PX), purified terephthalic acid |
| | (PTA) and acetic acid. |
| Changchun | polyether sulfone resin (PES), polyether |
| Jida High | ether ketone (PEEK). |
| Performance | |
| Materials | |
| China | |
| Cheil | ABS, PS, EPS and SAN. CMP(Chemical |
| South Korea | Mechanical Polishing) Slurry, CR(Color |
| | Resist), PI(Polyimide), PR(Photo Resist), |
| | Paste, EMS(Electro-Magnetic Interference |
| | Shielding), OPC(Organic Photo Conductor), |
| | Ink and highly functional engineering plastic |
| Chemopetrol | Ethylene, propylene, polyethylene, |
| Czech Pepubiic | polypropylene, benzene, ammonia |
| Chevron | Polyethylene (PE), K-Resin ® Styrene |
| Phillips | Butadiene Copolymers (SBC), Oxygen- |
| (CPC) USA | Scavenging Polymers (OSP), Phillips Sumika |
| | Polypropylene (PP), Ryton ® Polyphenylene |
| | Sulfide Resins (PPS), Normal Alpha Olefins |
| | (NAO) and Synfluid ® Poly Alpha Olefins |
| | (PAO) |
| Chi Mei | Abs Resin, San Resin, Ps Resin, Acrylic Resin, |
| Taiwan | Acrylic Sheet. Pc Resin, Pc/Abs Resin, Tpe, Q |
| | Resin, Br, Ssbr, Electronic Chemical, Optical |
| | Pmma Sheet, Ms Resin |
| Chisso | LIXON, LIXON Aligner, Chisso PBS Resist and |
| Japan | LIXON COAT |
| CTI | PVC Flexible, PVC Rigid, Temprene |
| USA | |
| Cyro | Acrylics |
| USA, | |
| Germany | |

Some general considerations of optical film design are described below. The term optical film when utilized herein may apply to one film having one optical function or to an a layered optical film having more than one optical film layered with other optical films having different functions. More than one sheet of optical films can be used in LCDs. When two or more optical films are used in lamination or stacking, the optical films may be stacked with or without gaps among them. It is generally preferred to stack the optical films with small gaps among them and to fix them to a film fixing frame. Here, the gap among the films can be changed in a broad range depending on a desired optical system in the optical film structure but is generally within the range of about 0.3 to 2.0 mm and preferably within the range of about 0.5 to 1.0 mm.

Various kinds of optical films are utilized in LCDs. The light diffusion film is ordinarily a film having a diffusion surface treatment that applies mat processing or emboss processing to a polymer film. It is also possible to employ other diffusion surface treatment by applying sand blast processing or by arranging a plurality of fine protuberances on the surface. Further, the light diffusion surface can be formed by internally dispersing diffusion particles such as TiO2. The light diffusion film can be formed from compositions containing a polycarbonate resin, an acrylic resin, a polyester resin, an epoxy resin, a polyurethane resin, a polyamide resin, a polyolefin resin, a silicone resin (inclusive of modified silicone such as silicone polyurea) and so forth in accordance with various molding methods. Concrete examples of the light diffusion film include an optical diffusion film “Opals Series”, products of Keiwa Co. The light diffusion film can be used at an arbitrary thickness depending on the object of use but should generally be selected in such a fashion as to reduce the thickness and the weight of the liquid crystal display device. Therefore, the thickness of the light diffusion film is generally within the range of about 5 to 1,000 μm, preferably within the range of about 5 to 500 μm and further preferably within the range of about 5 to 200 μm. The thickness of the light diffusion film is most preferably within the range of about 5 to 150 μm.

Luminance improving films (also called brightness enhancement films) that are generally used in this field of technology can be used as the luminance improving film. A typical luminance improving film is a luminance improving film having a prismatic shape. Concrete examples of the prism film that can be used in the practice of the invention include luminance improving films “BEFII Series”, “BEm Series”, “RBEF Series” and “NBEF Series” (trade names), products of 3M Co. The luminance improving film can be used at an arbitrary thickness, too, depending on the object of use. The thickness of the luminance improving film should be selected generally so as to reduce the size and the weight of the liquid crystal display device and is generally within the range of about 5 to 1,000 μm, preferably within the range of about 5 to 500 μm and further preferably within the rage of about 5 to 200 μm.

A film having a reflection type polarization property can be used for the luminance improving film. The reflection type polarization film is generally a polarization film that can transmit light in a vibration direction parallel to one in-plane axis (transmission axis) but can reflect other rays of light. In other words, this film transmits only the light component in the vibration direction parallel to the transmission axis described above among the rays of light incident into the polarization film and exhibits the polarization operation. Unlike the light absorption type polarization plate of the prior art, however, the rays of light that do not transmit the polarization film are not substantially absorbed by the polarization film. Therefore, the rays of light that are once reflected by the polarization film can be returned to the light source side and can travel again towards the reflection type polarization film by the reflection element disposed on the side of the light source such as the light diffusion film. Among the rays of light thus returned, only the light component in the vibration direction parallel to the transmission axis are transmitted and the rest are again reflected. Repetition of such transmission-reflection operations can increase the intensity of transmitted polarization light. A concrete example of such a reflection type polarization film is the “DBEF Series” and “DRPF-H Series” (trade names), products of 3M Co. A circular polarization element may be used in place of such a linear polarization element. An example of a circular polarization element is a cholesteric type circular polarization element that is commercially available under the trade name “Nipocs” from Nitto Denko K. K.

The reflection type polarization film can be used at an arbitrary thickness, too, depending on the object of use. The thickness of the reflection type polarization film should be selected generally so as to reduce the size and the weight of the liquid crystal display device and is generally within the range of about 15 to 1,000 μm, preferably within the range of about 30 to 500 μm and further preferably within the rage of about 50 to 200 μm.

The optical films concretely described above and other optical films that are useful for the practice of the invention can be used in arbitrary shapes and arbitrary sizes in the same way as their thickness. For example, the optical film may have an arbitrary shape such as a circle, an ellipse, a polygon, and so forth but has generally and preferably a rectangular (square or rectangular) shape. The area of such an optical film includes a small area to a large area depending on the object of use of the optical film structure and is generally within the range of about 1 cm² to 2 m². In the practice of the invention, the compression reducing mechanism exhibits its most effective operation when the area of the optical film is relatively large. In consequence, the occurrence of deformation and buckling of the film can be prevented while flatness of the film surface is kept. Therefore, it is recommended to use an optical film having a larger area. For example, the area of the optical film used in the invention in connection with a preferred screen size of a liquid crystal television unit is generally from about 15 to 20 inches or more.

The optical film of the present invention may be of any formable material, and is typically transparent. UV polymerizable materials, including acrylics, and polycarbonates are preferred materials. Generally, the UV polymerizable composition for making the light directing film includes a vinyl monomer, for example, an alkyl styrene monomer such as methyl styrene, and various co-monomers and/or oligomers. In one example, the composition comprises each of bisphenol-A epoxy diacrylate, novolak epoxy acrylate, and a vinyl monomer, which includes alkyl styrenes (for example, methyl styrene); such a composition is considered an “epoxy acrylate”. An initiator may be added to provide a free radical source to initiate polymerization of the composition to a polymerized structure. Other materials useful for layers of the optical films are polyethylene terephthalate (PET), polyethylene naphthalate (PEN), polyethersulfone (PES), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl α-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic film is a cyclic polyolefin or a polyester. Various cyclic polyolefins are suitable for the flexible plastic film. Examples include Arton® made by Japan Synthetic Rubber Co., Tokyo, Japan; Zeanor T made by Zeon Chemicals L.P., Tokyo Japan; and Topas® made by Celanese A. G., Kronberg Germany. Arton is a poly(bis(cyclopentadiene)) condensate that is a film of a polymer. Alternatively, the flexible plastic film can be a polyester. A preferred polyester is an aromatic polyester such as Arylite. Although various examples of plastic films are set forth above, it should be appreciated that the film can also be formed from other materials such as glass and quartz.

A variety of polymer materials suitable for use in the present invention have been taught for use in making multilayer optical films. For example, the polymer materials listed and described in U.S. Pat. Nos. 4,937,134, 5,103,337, 5,448,404, 5,540,978, and 5,568,316 to Schrenk et al., and in U.S. Pat. Nos. 5,122,905, 5,122,906, and 5,126,880 to Wheatley and Schrenk are useful for making multilayer optical films according to the present invention.

The layers of the optical films are usually made from polymeric synthetic resins, which may be combined with other ingredients, such as curatives, fillers, reinforcing agents, colorants, and plasticizers. Plastic includes thermoplastic materials and thermosetting materials. The optical films must have sufficient thickness and mechanical integrity so as to be self-supporting, yet should not be so thick as to be rigid.

Another significant characteristic of the layers of the optical films are their glass transition temperatures (Tg). Tg is defined as the glass transition temperature at which plastic material will change from the glassy state to the rubbery state. It may comprise a range before the material may actually flow. Suitable materials for the flexible plastic film include thermoplastics of a relatively low glass transition temperature, for example up to 150° C., as well as materials of a higher glass transition temperature, for example, above 150° C. The choice of material for the flexible plastic film would depend on factors such as manufacturing process conditions, such as deposition temperature, and annealing temperature, as well as post-manufacturing conditions such as in a process line of a displays manufacturer. Certain of the plastic films discussed below can withstand higher processing temperatures of up to at least about 200° C., some up to 300-350° C., without damage.

The layers of the optical films can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the film, different hard coatings can be used. When the film is polyester or Arton, a particularly preferred hard coating is the coating known as “Lintec.” Lintec contains UV-cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

As noted above, the present invention relates to an optical film that is part of a back light module that is generally used in an LCD device. Since liquid crystal displays are lighter and more compact display devices than CRTs, they find extensive application in computers, electronic calculators, clocks, and watches. The principle of operation of liquid crystal displays depends on a change in an optical property, such as interference, scattering, diffraction, optical rotation, or absorption, of a liquid crystal material. This change is caused by a variation in orientation of the liquid crystal molecules or a phase transition in response to application of an external field such as electric field or heat.

To date, twisted nematic (TN) liquid crystal displays and supertwisted nematic (STN) liquid crystal displays enjoy wide acceptance. These kinds of liquid crystal displays make use of optical properties of liquid crystal materials such as optical rotation and interference of birefringent light. Both kinds require polarizing plates.

The following examples are intended to illustrate but not to limit the invention.

### EXAMPLES

This example illustrates the effect of the compression reducing mechanism on eliminating buckling of optical films, as determined by finite element analysis. In accordance with conventional finite element analysis techniques, the first step is to generate a geometric representation of the optical film using discrete elements (also called a mesh). ABAQUS®, a finite element software package commercially available from Hibbitt, Karlsson & Sorensen, Inc. (Pawtucket, R.I.), is used to analyze the thermal and mechanical performance of the optical films and compression reducing mechanism. This software gives displacement contours indicating the magnitude and location of the buckling.

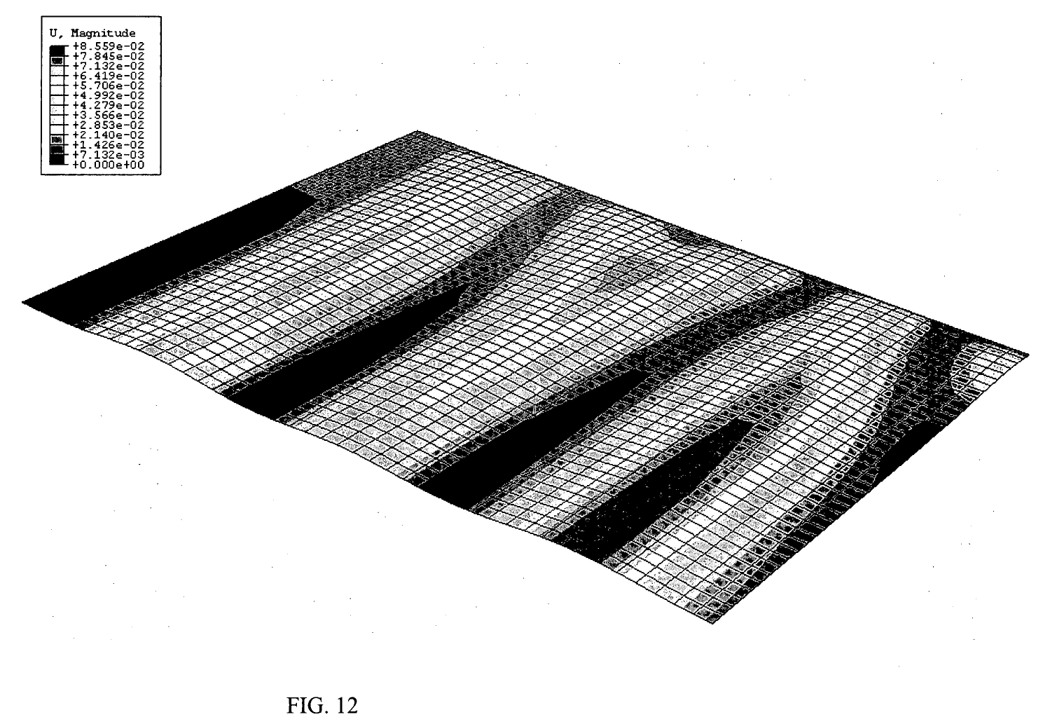

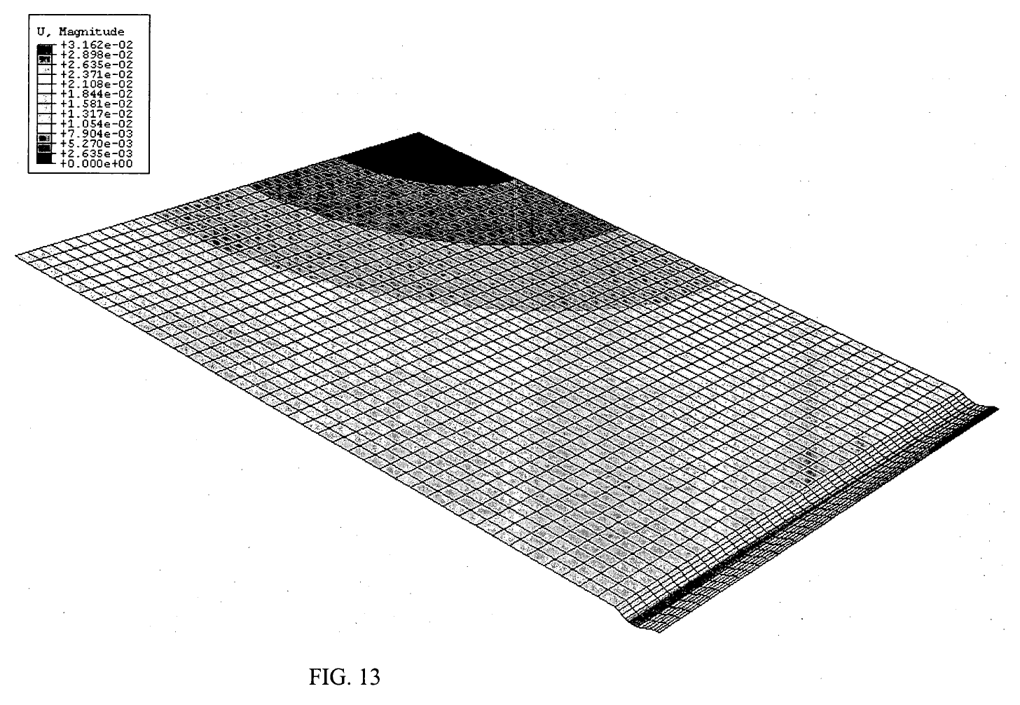

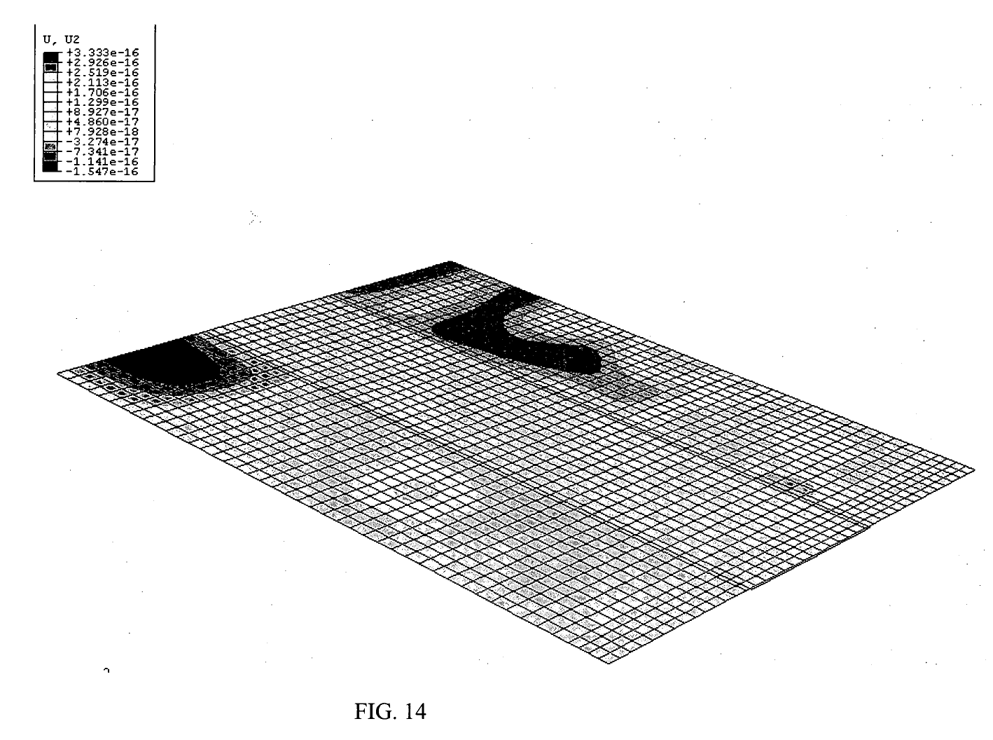

The model is based on a quarter section of a 19 inch monitor. The thickness of the optical film is 6 mil of polycarbonate. The gap between the optical film and the optical frame is 41 mil. The film has coefficient of thermal expansion 60 ppm/C. When the temperature is increased by 30 C from the room temperature, buckling is observed, FIG. 12. When a buckling section is introduced, with the thickness of 2 mil, buckling of the optical film is limited only in the buckling section, FIG. 13. Furthermore, when the compression reducing spring is introduced with a spring constant of 50 lb/in, buckling is eliminated, FIG. 14.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

### PARTS LIST

1. optical film
100. back light module
11. light guiding plate
12. reflective plate
13. lamp
14. optical film assembly
15. back cover
16. diffusion dots
141. lower diffusion sheet
142. prism sheet
143. reflective polarizing film
10. main section of the optical film
20. buckling section of the optical film
30. end section of the optical film
40. optical frame
110. main section of the optical film
120. buckling section of the optical film
130. end section of the optical film
140. optical frame
220. end plate with attached spring
210. optical film
230. bending element
240. optical frame
250. gap
350. stamp
450. optical film
550. hot plate

1. An optical film/frame combination wherein the optical film comprises a viewing portion and wherein either the film or the frame, or both, comprises a compression reducing mechanism for allowing the film to expand within the frame without distortion of the viewing portion of the film.

2. The optical film/frame combination of claim 1 wherein the optical film comprises the compression reducing mechanism, said compression reducing mechanism being a compression reducing portion of the film.

3. The optical film/frame combination of claim 2 wherein the optical film comprises the compression reducing portion on at least one edge of the film and wherein the compression reducing portion of the film has a lower resistance to thermal driven buckling than the viewing portion.

4. The optical film/frame combination of claim 3 wherein the optical film comprises the compression reducing portion on at least one edge of the film and wherein the bending stiffness of the compression reducing portion of the film is 80% or less of the bending stiffness of the optical film in the viewing portion.

5. The optical film/frame combination of claim 3 wherein the viewing portion and the compression reducing portion of the film are comprised of the same material.

6. The optical film/frame combination of claim 3 wherein the compression reducing portion of the film is thinner than the viewing portion of the film.

7. The optical film/frame combination of claim 3 wherein the compression reducing portion of the film has a Young's modulus that is at least 20% lower than that of the viewing portion of the film.

8. The optical film/frame combination of claim 3 wherein the compression reducing portion of the film is grooved.

9. The optical film/frame combination of claim 3 wherein the compression reducing portion of the film is discontinuous.

10. The optical film/frame combination of claim 3 wherein the optical film consists of material with a coefficient of thermal expansion higher than 10 ppm/C.

11. The optical film/frame combination of claim 3 wherein the optical film consists of polycarbonate.

12. The optical film/frame combination of claim 3 wherein the optical film consists of polyethylene terephthalate (PET), polyethylene naphthalate (PEN) or polyethersulfone (PES).

13. The optical film/frame combination of claim 3 wherein the viewing portion and the compression reducing portion of the film are comprised of different materials.

14. The optical film/frame combination of claim 1 wherein the frame comprises the compression reducing mechanism.

15. The optical film/frame combination of claim 14 wherein the compression reducing mechanism is at least one bending element located between the frame and the film and wherein said bending element deflects to provide resistance to the optical film.

16. The optical film/frame combination of claim 15 wherein the bending element is made of thermoplastic with a Young's modulus higher than 1 GPa.

17. The optical film/frame combination of claim 14 wherein the compression reducing mechanism is at least one compression element located between the frame and the film and wherein said compression element deforms to provide resistance to the optical film.

18. The optical film/frame combination of claim 17 wherein the compression element is made of a rubbery material.

19. The optical film/frame combination of claim 18 wherein the compression element is made of polyurethane or polystyrene.

20. The optical film/frame combination of claim 14 wherein the compression reducing mechanism is at least one spring located between the frame and the film.

21. The optical film/frame combination of claim 14 wherein the compression reducing mechanism has a spring constant that satisfies the conditions
$$\begin{matrix}k \geq \frac{αΔ TEh}{g} \\ and & ( 2 a ) \\ k \leq \frac{{N}_{cr} Eh}{( αΔ TEh - {N}_{cr} ) L} & ( 2 b )\end{matrix}$$

22. The optical film/frame combination of claim 1 wherein the optical film has a diagonal dimension of 9 to 70 inches.

23. The optical film/frame combination of claim 1 wherein the optical film has a diagonal dimension of 19 to 55 inches.

24. An optical film comprising a viewing portion and a compression reducing portion, said compression reducing portion allowing the film to expand within a frame without distortion of the viewing portion of the film.

25. The optical film of claim 24 wherein the optical film comprises the compression reducing portion on at least one edge of the film and wherein the compression reducing portion of the film has a lower resistance to thermal driven buckling than the viewing portion.

26. The optical film of claim 24 wherein the optical film comprises the compression reducing portion on at least one edge of the film and wherein the bending stiffness of the compression reducing portion of the film is 80% or less of the bending stiffness of the optical film in the viewing portion.

27. The optical film of claim 24 wherein the viewing portion and the compression reducing portion of the film are comprised of the same material.

28. The optical film of claim 24 wherein the compression reducing portion of the film is thinner than the viewing portion of the film.

29. The optical film of claim 24 wherein the compression reducing portion of the film has a Young's modulus that is at least 20% lower than that of the viewing portion of the film.

30. The optical film of claim 24 wherein the compression reducing portion of the film is grooved.

31. The optical film of claim 24 wherein the compression reducing portion of the film is discontinuous.

32. The optical film of claim 24 wherein the optical film consists of material with a coefficient of thermal expansion higher than 10 ppm/C.

33. The optical film of claim 24 wherein the optical film consists of polycarbonate.

34. The optical film of claim 24 wherein the optical film consists of polyethylene terephthalate (PET), polyethylene naphthalate (PEN) or polyethersulfone (PES).

35. The optical film of claim 24 wherein the viewing portion and the compression reducing portion of the film are comprised of different materials.

36. The optical film of claim 24 wherein the optical film has a diagonal dimension of 9 to 70 inches.

37. The optical film of claim 24 wherein the optical film has a diagonal dimension of 19 to 55 inches.

38. An optical frame suitable for holding an optical film wherein said optical film comprises a viewing portion, and said frame comprises a compression reducing mechanism for allowing the film to expand within the frame without distortion of the viewing portion of the film.

39. The optical frame of claim 38 wherein the compression reducing mechanism is at least one bending element located along at least one edge of the frame and wherein said bending element deflects to provide resistance to the optical film

40. The optical frame of claim 39 wherein the bending element is made of thermoplastic with a Young's modulus higher than 1 GPa.

41. The optical frame of claim 38 wherein the compression reducing mechanism is at least one compression element located along at least one edge of the frame and wherein said compression element deforms to provide the resistance to the optical film.

42. The optical frame of claim 41 wherein the compression element is made of a rubbery material.

43. The optical frame of claim 42 wherein the compression element is made of polyurethane or polystyrene.

44. The optical frame of claim 38 wherein the compression reducing mechanism is at least one spring located along at least one edge of the frame.

45. The optical frame of claim 38 wherein the compression reducing mechanism has a spring constant that satisfies the conditions.
$$\begin{matrix}k \geq \frac{αΔ TEh}{g} \\ and & ( 2 a ) \\ k \leq \frac{{N}_{cr} Eh}{( αΔ TEh - {N}_{cr} ) L} . & ( 2 b )\end{matrix}$$

46. The optical film/frame combination of claim 1 wherein both the film and the frame comprise a compression reducing mechanism.
